(19) United States
(12) Patent Application Publication
(10) Pub. No.: US 2026/0024008 A1
(43) Pub. Date: Jan. 22, 2026

(54) ADDRESSING WEIGHT DIVERGENCE WHILE LEARNING MULTIPLE TASKS CONTINUOUSLY ON DISTRIBUTED DEVICES

(71) Applicant: Dell Products L.P., Round Rock, TX (US)

(72) Inventors: Isabella Costa Maia, Bertioga (BR); Karen Braga Enes, Belo Horizonte (BR); Karen Stéfany Martins, Belo Horizonte (BR); Luiz Fernando Sommaggio Coletta, Rio Claro (BR); Pablo Nascimento da Silva, Niterói (BR)

(21) Appl. No.: 18/777,383

(22) Filed: Jul. 18, 2024

(51) Int. Cl. G06N 20/00

(52) U.S. Cl. CPC G06N 20/00

(57) ABSTRACT

Techniques for training a global ML model are disclosed. A service tasks nodes to assist in training the model by updating global model parameters. The service instructs the nodes to contribute to the training by causing each node to update a corresponding task-specific parameter associated with a local node task. The service receives, from the nodes, masked data, which include masked versions of the updated task-specific parameters. The service determines that the masked data are masked using pairwise masking vectors. The service cancels the pairwise masking vectors by aggregating the masked data together, resulting in the task-specific parameters being unmasked. The service updates the global model parameters using the unmasked task-specific parameters. The service distributes updates, which are based on the updated global model parameters, to the nodes to facilitate local model updates at the nodes.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to training machine learning models. More particularly, at least some embodiments relate to systems, hardware, software, computer-readable media, and methods for using nodes in a continual federated learning environment to assist in training a global machine learning model in a distributed and modular manner.

### BACKGROUND

Continual Learning (CL) studies the problem of building machine learning models that continuously learn through a sequence of tasks, so that new knowledge is acquired without forgetting the knowledge previously attained in earlier tasks. Task-agnostic continual learning can be seen as one specific and challenging scenario, where task identities and boundaries are not known by the learning algorithm during training. For example, during a given time, a task arrives for training, but the learning algorithm does not have any information about the task (e.g., image classification of a specific object, such as cars) nor does the algorithm have the boundaries of the task (e.g., when the task ends, so that images of cars can appear together with images of motorcycles).

Federated Learning (FL) is a strategy for distributed training of Artificial Intelligence (AI) models, where multiple nodes contribute to the training with their own separate datasets. This is particularly relevant with the rise of edge device related applications and the advent of large multicenter or multiorganization collaborations, where pooling the data and resources from various nodes can create much stronger models compared to each node training their own individual AI. Yet, in many situations, it might be desirable or mandatory for these nodes to maintain the privacy of their datasets. Some common examples include hospitals with private patient information, cellphones with personal private photos, conversations, voice recordings, and similar. A central concept of FL is ensuring privacy during training rounds.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example architecture for training a global model.

FIG. 2 illustrates an example of the weight divergence problem.

FIG. 3 illustrates a masking scheme.

FIG. 4 illustrates an example model diagram.

FIG. 5 illustrates another architecture in which a central node orchestrates various sub-nodes.

FIG. 6 illustrates various masked tasked vectors.

FIG. 7 illustrates a process flow of the training process.

FIG. 8 illustrates a flowchart of an example method for the training process.

FIG. 9 illustrates an example computer system that can be configured to perform any of the disclosed operations.

### DETAILED DESCRIPTION

FL strategies can face challenges when dealing with particular scenarios in which data is not independent and identically distributed (“non-IID”). For instance, a recurrent problem is the low convergence of the FL's global model. This problem is called “weight divergence.”

On the other hand, CL applications often deal with non-IID scenarios because input streams can correspond to multiple different tasks issued from different distributions. This disclosure presents a strategic technique to perform CL in distributed, privacy induced scenarios (e.g., such as FL) in order to avoid weight divergence.

In particular, the disclosed embodiments provide numerous benefits, advantages, solutions, and practical applications to machine learning. By way of example, the disclosed embodiments provide solutions to the following problems. One problem with traditional techniques concerns limited resources for training the CL algorithms. The FL framework allows the disclosed embodiments to collectively train a global model with each node of the federation using only a fraction of the computational power and data usually required to train those models.

Another problem with the traditional techniques concerns data privacy and bandwidth. The disclosed FL framework ensures data privacy for each node of the federation, thereby avoiding data orchestration to a central server and thus reducing bandwidth requirements.

Another issue that has traditionally been a problem relates to the synchronization of the global model for multiple tasks. The disclosed embodiments beneficially allow nodes with yet unknown distributions to readily react to a task previously seen by other nodes on the federation. The disclosed embodiments also beneficially train a continual learning model in a distributed fashion while achieving a threshold level of global model convergence.

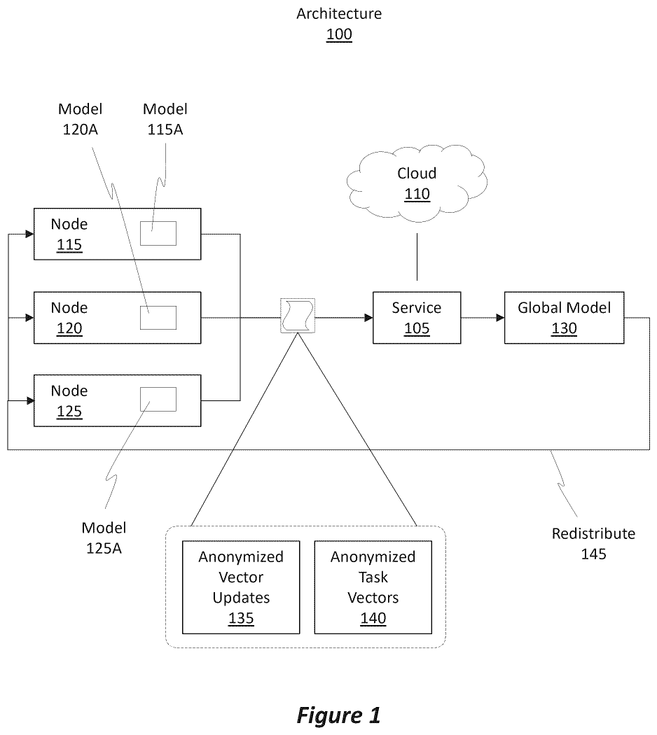

Attention will now be directed to FIG. 1, which illustrates an example architecture 100 in which the disclosed principles may be employed. Architecture 100 shows a service 105.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine. The ML engine enables service 105 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a local service operating on a local device. In some implementations, service 105 is a cloud service operating in a cloud 110 environment. In some implementations, service 105 is a hybrid service that includes a cloud component operating in the cloud and a local component operating on a local device. These two components can communicate with one another.

Service 105 is shown as interacting with a number of nodes, such as nodes 115, 120, and 125. While only three nodes are illustrated in FIG. 1, it should be appreciated how any number of nodes can be present within architecture 100. Service 105 can thus be viewed as being a central node that works in tandem with the remote edge nodes. Together, these nodes are task with maintaining and/or updating a global model 130. The updated model (or parameters of the model) can then be transmitted to the remote nodes to enable them to experience continual learning. The remote nodes (e.g., nodes 115, 120, and 125) can be viewed as being edge nodes or edge devices. Each edge node hosts a model that operates on tasks and that can be updated. To illustrate, node 115 hosts model 115A; node 120 hosts model 120A; and node 125 hosts model 125A.

Generally, architecture 100 reflects a pipeline that facilitates continual federated learning in a resource constrained edge scenario, thereby ensuring data privacy and global model convergence. The disclosed solutions can, though are not required to, implement the Expert Prompt Pool (E-prompt) and General Prompt Pool (G-prompt) presented in the DualPrompt algorithm.

In some scenarios, service 105 is tasked with building a pool of Expert Prompts (E-Prompts) in a federated fashion. Applying FL directly would pose additional challenges because each edge node is dealing with a specific task, so updating the model using a standard approach could lead to catastrophic forgetting (i.e., a model that only works well on some tasks).

To address this problem, the disclosed embodiments are directed to various techniques for training the continual learning model in parts while building a single model able to tackle multiple tasks. Each part is a group of nodes that address the same task or a specific group of tasks. These groups are found automatically during the execution of the procedure.

The model can be performed in at least the following manner. The central node (CN) (e.g., the service 105) starts the federation. Service 105 starts random initialization of DualPrompt model and distributes it to the edge nodes 115, 120, and 125.

Service 105 starts a single Secure Aggregation protocol for all the edge nodes 115, 120 and 125 in the Federation. For each FL round, each edge node trains its local model (e.g., models 115A, 120A, and 125A). Each edge node 115, 120, and 125 constructs an anonymized task vector. Each edge node 115, 120, 125 sends its anonymized vector updates for the learnable parameters (e.g., as shown by anonymized vector updates 135) and anonymized task vector (e.g., as shown by anonymized task vector 140) to service 105.

Service 105 then aggregates the anonymized vector updates and task vectors and updates the global model 130. Service 105 redistributes the updated model to the edge nodes 115, 120, and 125, as shown by redistribute 145.

In this manner, service 105 is able to collectively train a single model (e.g., global model 130) by a non-IID federation of nodes (e.g., the combination of nodes 115, 120, and 125), thereby allowing for each one of those nodes to contribute to the training of the single global model in a modular fashion. Such training is implemented by updating only the task-specific parameters that correspond to the current locally addressed task, which is dynamic because data distributions are allowed to shift locally between FL rounds. Every node is beneficially structured to readily react to tasks never seen before locally but that were learned before by other members in the Federation. These benefits can be achieved while not incurring redundancy cost issues of owning models for multiple data distributions because the embodiments build a single unified model for all the tasks and because the prompts are a lightweight solution.

The embodiments also help guarantee data privacy in the Federation. The embodiments allow for the nodes to frequently change between the training of task prompts because there is not a requirement to maintain a rigid cluster structure. The embodiments also allow each node to contribute to the model parameters corresponding to that node's local task without incurring in the costs of restarting a secure aggregation protocol each time a distribution shifts. Having just explained the concepts at a high level, the disclosure will now provide a more detailed explanation of the disclosed principles.

### Weight Divergence in Federated Learning

Federated learning can use an algorithm referred to as the Federated Average (FedAvg) algorithm. In this algorithm, client devices perform several rounds of stochastic gradient descent (SGD) locally before sending updated model information to the central node, prioritizing low communication over calculation efficiency.

When collectively learning a multitask model, it is common to have a scenario where client's data reflects only partially the tasks addressed by the federation as a whole and presents high data heterogeneity. Data heterogeneity in federated learning is characterized by differences in data distribution and quantity, which can vary significantly due to environmental preferences and usage patterns.

However, the involvement of non-IID data can lead to a problem known as “weight divergence.” That is, as the degree of non-IID data increases, the divergence between the model parameters obtained by FedAvg and those that would be obtained using a centralized training method will cumulatively increase across FL rounds. This problem can both hinder the performance of the global model (e.g., when compared to the IID scenario) and can aggravate the performance fairness issue, which means that the established model yields significantly different performance across clients.

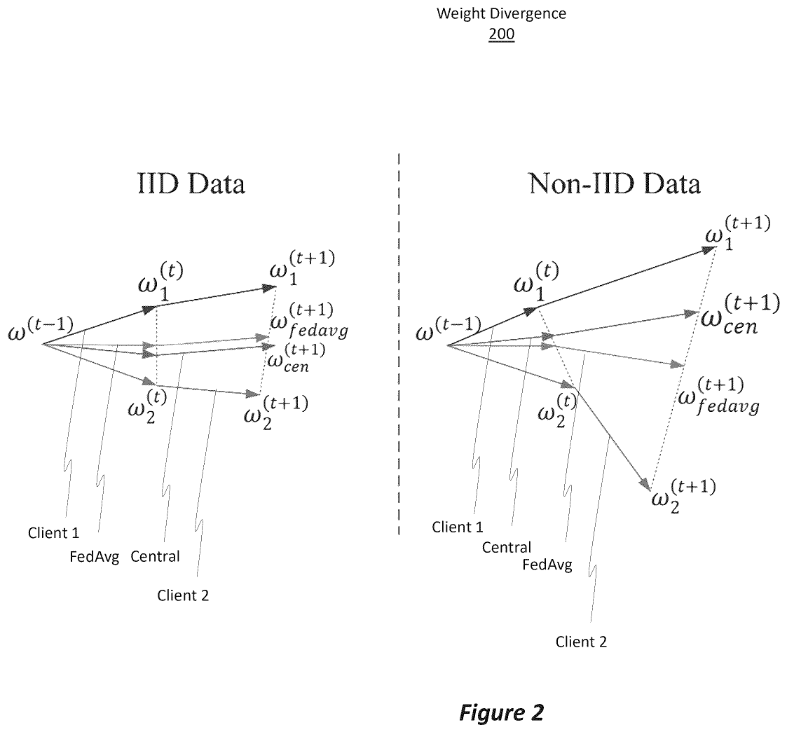

FIG. 2 shows an example of the weight divergence 200 difference between scenarios involving the use of IID data and non-IID data. The model parameters obtained by the centralized training method and those obtained by FedAvg at iteration t are represented as ω^{t}_{cen} and ω^{t}_{fedavg} respectively.

The above problem has attempted to be addressed by training multiple disjoint models that are targeted to clusters of similar clients. This technique is known as Hierarchical Federated Learning (HFL) and has the intention to improve the performance of the training objective for all clients whilst reducing communication in the FL protocol. This approach builds a single global model and allows for every node in the federation to readily react to unseen tasks. HFL also clusters the user devices to independently train multiple specialized models in parallel. While HFL has uses, it is not an ideal approach, particularly when it comes to securing data.

### Secure Aggregation

Model updates transferred between nodes in FL still carries information that can be used to infer properties of (or sometimes even recover parts of) the data used for training. Therefore, under strong privacy guarantees, the FL framework described herein incorporates a secure aggregation protocol.

The concept is that instead of having access to each edge node's update, service 105 of FIG. 1 (i.e. the “central node”) will have access only to a sum of the edge node's updates. That is, the objective is for a protocol where service 105 can learn only the sum of K inputs, where these inputs are the (large) update vectors from each edge node. One aspect of the protocol is that edge nodes will construct pairwise masking vectors that cancel out with each out when they are summed together at service 105.

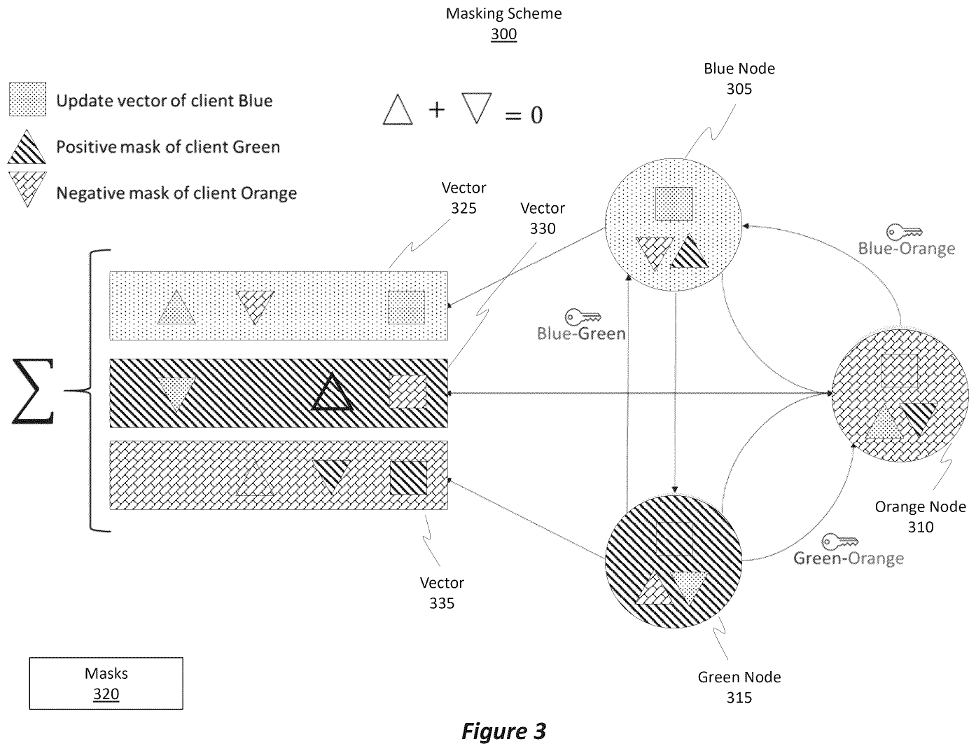

FIG. 3 shows an example masking scheme 300 that can accomplish the above data security objective. In particular, FIG. 3 shows a graphical representation of the secure aggregation protocol, where three nodes (e.g., blue node 305, orange node 310, and green node 315) construct pairwise masks 320 that cancel out when the data is aggregated (e.g., as shown by the summation symbol) at the central node. The masks 320 include a positive mask (e.g., the triangle symbol pointing upward) and a negative mask (e.g., the triangle symbol pointing downward). When aggregated together, these two masks cancel each other out, thereby allowing the underlying data to be revealed. If a malicious or curious attacker has access to one of the vectors coming from a given participant edge node, that attacker will not be able to uncover confidential information because the vector has only half of the needed information to unmask the underlying data.

FIG. 3 shows three vectors (e.g., vector 325, vector 330, and vector 335). Vector 325 originates from the blue node 305, as evidenced by the shading scheme (e.g., the dotted pattern). Green node 315 created vector 330, and orange node 310 created vector 335, with corresponding shading schemes.

Vector 325 includes one positive “blue” mask that can be cancelled out only by a negative “blue” mask, which is found in vector 330. Vector 325 also includes one negative “orange” mask that can be cancelled out only by a positive “orange” mask, which is found in vector 335.

Vector 330 includes one negative “blue” mask that can be cancelled out only by the positive “blue” mask found in vector 325. Vector 330 also includes one positive “green” mask that can be cancelled out only by the negative “green” mask found in vector 335.

To complete the example, vector 335 includes one positive “orange” mask that can be cancelled out only by the negative “orange” mask found in vector 325. Vector 335 also includes one negative “green” mask that can be cancelled out only by the positive “green” mask found in vector 330.

The central node receives vectors 325, 330, and 335. The central node then aggregates these vectors together, thereby allowing the positive and negative masks to cancel each out other, resulting in the update vectors (e.g., the small squares in FIG. 3) being revealed.

In some implementations, the disclosed embodiments adapt the DualPrompt solution in which a single general prompt (G-prompt) is used to encode common knowledge and T prompts are used to encode information from T tasks, one for each of them, called expert prompt (E-prompt). G- and E-prompts encode respective types of instructions during training with the backbone and cooperatively instruct the model to make predictions at inference.

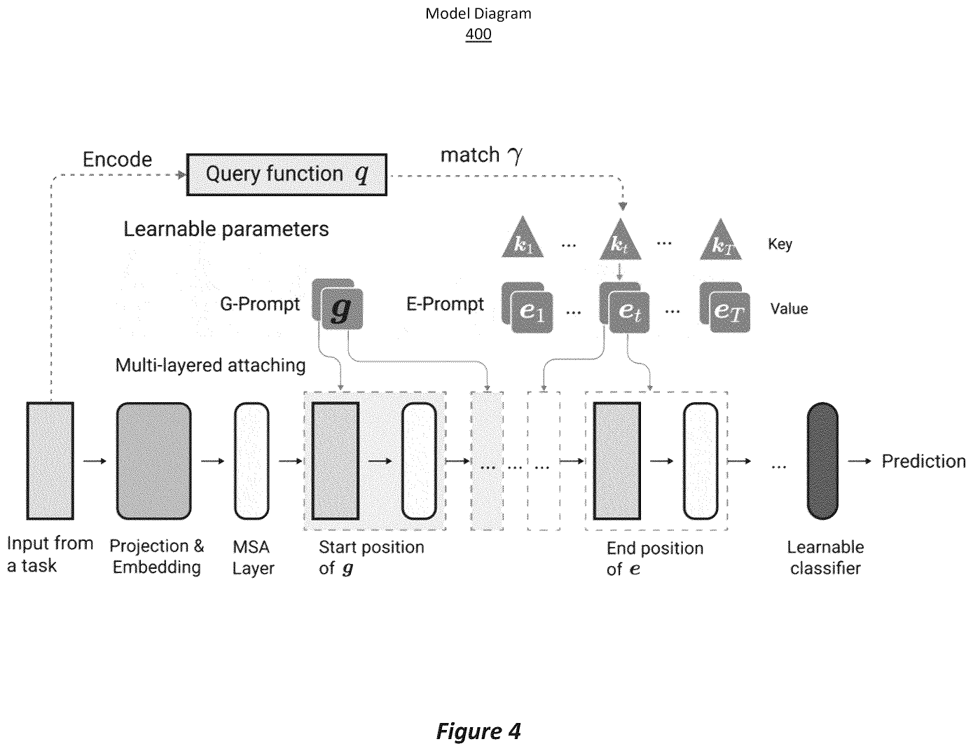

Each one of the latter prompts is associated as value to a key and, each time a new input is fed into the model, a deterministic embedding function encodes it to the key dimension. Then, using a distance metric, the algorithm queries the closest key to the encoded input. The prompt associated with this key summarizes the task information for that input and is attached to multiple multi-head self-attention (MSA) layers of a transformer model whose goal is to perform a classification. The G-prompt is also attached to a MSA layer at the beginning of the model. The general model diagram is illustrated in FIG. 4 by model diagram 400. In particular, model diagram 400 shows the DualPrompt at test time. The eᵢ vectors represent the expert prompts, which are the encoded information contained in the prompt pool addressed herein.

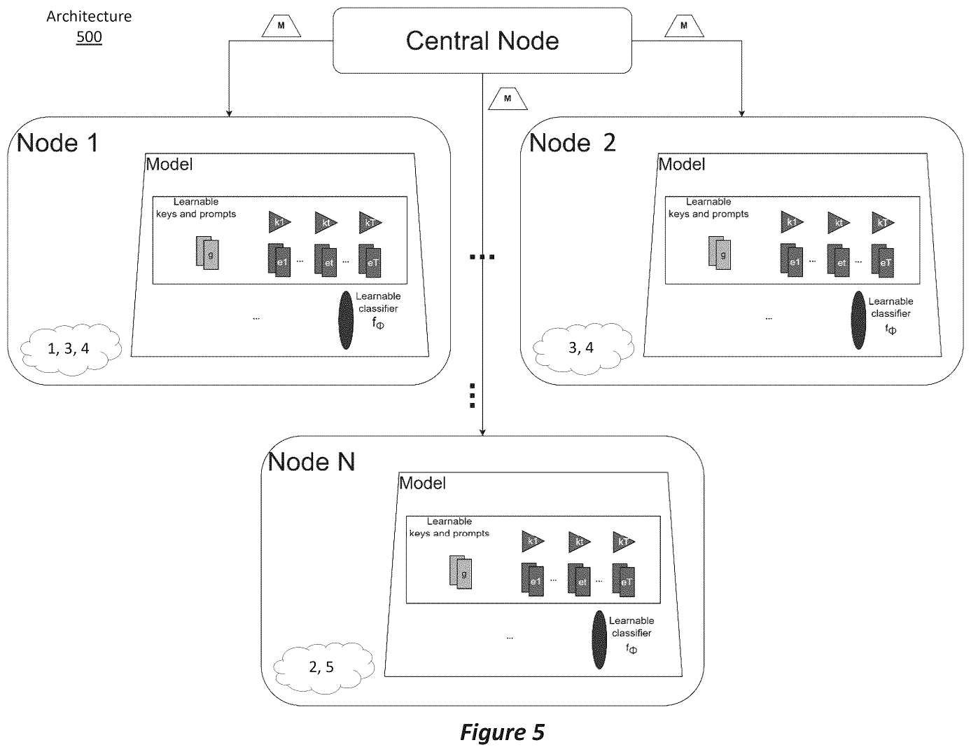

FIG. 5 illustrates another example architecture 500 in which the disclosed principles can be employed. For instance (and with reference to FIG. 5), the federation is formed by a central node “CN” and N device nodes capable of, together, learning T tasks. The CN starts the federation. The CN starts a single DualPrompt model M with random initializations of the learnable parameters (g, {eᵢ}_{(i=1, . . . , T)}, {kᵢ}_{(i=1, . . . , T)} and Φ) and distributes it across the N federation nodes.

The CN starts a single secure aggregation protocol for all the client nodes in the federation, enabling the ensemble of nodes to create pair-wise cancelling masks for hiding both the learnable parameters' gradients and task vectors. In some cases, the task vectors include the metadata communicated by a node to the CN during each FL round containing the information of which expert prompt is being trained.

In traditional HFL scenarios, a given node is expected to present a steady data distribution such that clustering the federation results in a constant configuration across FL rounds. In scenarios where nodes incrementally learn different tasks, however, it is reasonable to presume that a given node will be presented to an ever-changing data stream reflecting the current task distribution at hand.

Because of that, working under the usual HFL scenario would result in many different clustering configurations during FL rounds, requiring resetting the whole secure aggregation protocol within clusters each time a node entered or left one of them because of a change in the local addressed task. Such a scenario operates as a large impediment because the computation cost of this protocol is quadratic for device nodes and cubic for the CN.

Conversely, naively applying the secure aggregation protocol across the entire federation, in the traditional FL scenario, would require nodes to communicate the currently trained task identity. This is because each node is likely to generate a sparse gradient vector since, in each FL round, each node trains a specific and possibly different set of expert prompt(s). Therefore, applying FedAvg would require the CN to acknowledge how many nodes contribute to the updates of each Expert Prompt so as to calculate the average update for each of them.

However, if each node communicated on the clear which expert prompt is being locally trained, the Federation would have its privacy breached. Once in possession of this information, the CN could easily infer the update vector mask values at all the positions corresponding to the non-trained expert prompts from a node, since the true update values would be zero in these positions. In this scenario, the secure aggregation protocol would also have to be restated each time a node shifted its training task.

Considering those hurdles, the disclosed embodiments present various techniques that spare computational and communication costs by relying on a single secure aggregation statement for enabling data privacy in the Federation training even when working with shifting training tasks and sparse update vectors. This benefit is achieved by anonymizing the training task identity of each node across FL rounds.

For every FL round, a node n from the Federation shares with the CN not only its update vector for training the learnable parameters, but also its task vector γⁿ∈{0,1}^{T} with its i-th position:

$${y}_{i}^{n} = \{ \begin{matrix}1 , & if e\_i is trained by n in the given round \\ 0 , & otherwise\end{matrix}$$

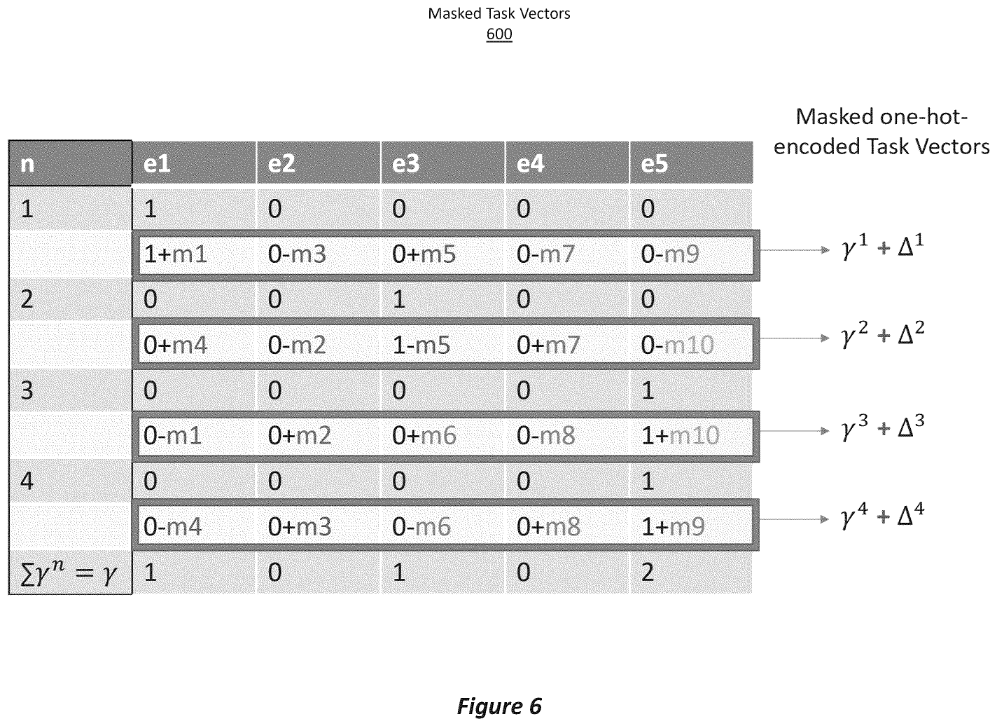

In other words, the above description relates to a T-dimensional one-hot encoded vector one-valued in the positions corresponding to the trained expert prompts in the current round and zero-valued at the other positions. Before communicating the task vector to the CN, the task vector is anonymized by adding it to the mask vector Δⁿ calculated by the nodes in the federation's start. The process is illustrated in FIG. 6 with the masked task vectors 600. In this example scenarios, the masked task vectors 600 have T=5 and N=4. The bolded rectangles indicate the task vector added to the masking vector. For node n=1, γⁿ=[1,0,0,0,0] and Δⁿ=[m1, −m3, m5, −m7, −m9].

It can be observed that at the federation's start, the mask vectors Δⁿ are created such that the masking values mi are canceled out in the sum of the anonymized task vectors, resulting in a vector γ where each coordinate γᵢ represents the number of nodes training an expert prompt eᵢ in each FL round. The central node uses the bit-level values of γ to conclude the FedAvg algorithm by dividing the sum of update vectors of each Expert Prompt by the respective γᵢ coordinate value.

For each FL round, a number of operations are performed. One operation includes each edge node training its local model using its own private data and calculating the gradients for eᵢ, {kᵢ}_{(i=1, . . . , T)}, g and Φ and adding them to their respective mask vector.

Another operation includes each model constructing its anonymized task vector according to the expert prompt(s) selected during training, when a distance metric is calculated between input query and keys. Each node anonymizes its task vector γⁿ by adding it to its mask vector Δⁿ.

Another operation includes each edge node sending its anonymized local update values for learnable parameters (update gradients/parameters for eᵢ, {kᵢ}_{(i=1, . . . , T)}, g and Φ) and anonymized local task vector to the CN.

Another operation includes the CN summing the update values for eᵢ, g, and Φ and summing the anonymized task vectors received from the nodes, cancelling out the mask values and obtaining γ.

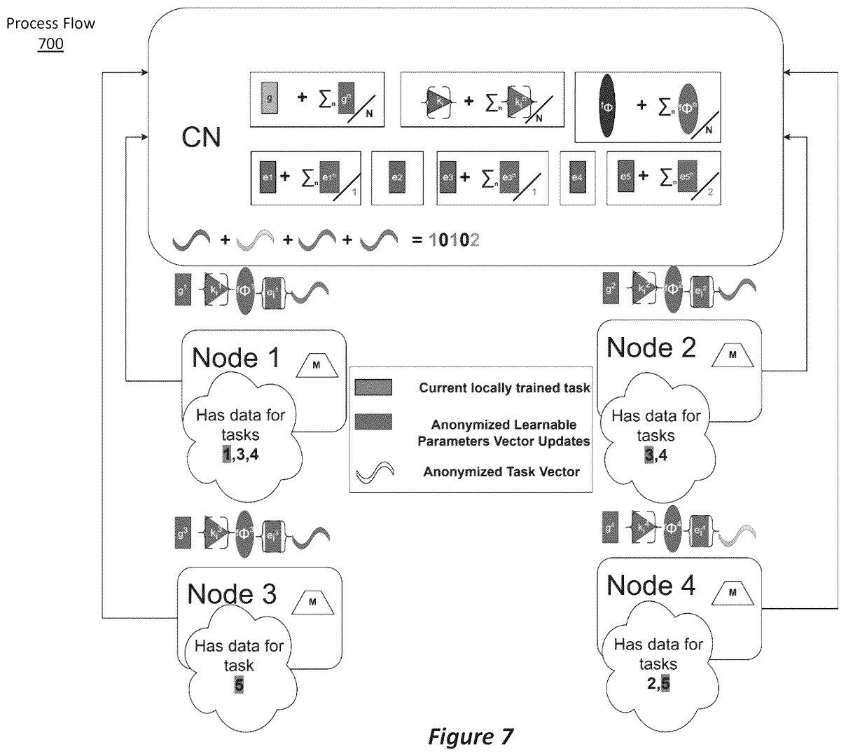

Another operation includes the CN applying FedAvg by dividing update values for g, {kᵢ}_{(i=1, . . . , T)} and Φ by the number of nodes participating in the FL round and dividing eᵢ update values by vi. The CN updates the global model parameters values {eᵢ, {kᵢ}_{(i=1, . . . , T)}, g, Φ} and sends it back to all edge nodes. FIG. 7 shows an example process flow 700 representative of the above operations.

With reference to FIG. 7, the CN updates its model's learnable parameters (g, {eᵢ}_{(i=1, . . . , T)}, {kᵢ}_{(i=1, . . . , T)} and Φ depicted in FIG. 7). Note that each node locally trains a task and communicates its parameter's updates (gⁿ, {eᵢ}_{(i=1, . . . , T)}ⁿ, {kᵢ}_{(i=1, . . . , T)}ⁿ, Φⁿ, n∈1, . . . , 4) together with its anonymized task vector which, individually, shares no information about its identity.

The globally federated parameters (g, {kᵢ}_{(i=1, . . . , T)}, and Φ) are added to the sum of the node's update contributions divided by the number of nodes N=4 in the Federation. The Expert Prompts {eᵢ}_{(i=1, . . . , T)}, on the other hand, are added to the sum of the node's updates divided by the i-th coordinate of the resulting task vector. In the example above, γ=Σₙ γⁿ=10102, so the resulting updates are

$$\frac{{\sum }_{n} {e}_{1}^{n}}{1} , 0 , \frac{{\sum }_{n} {e}_{3}^{n}}{1} , 0 , \frac{{\sum }_{n} {e}_{5}^{n}}{2}$$

for Expert Prompts e₁, e₂, e₃, e₄, and e₅, respectively. Note that, when γᵢ=0, the embodiments can choose to not update eᵢ (same as adding 0) instead of dividing the update vector by this coordinate value.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

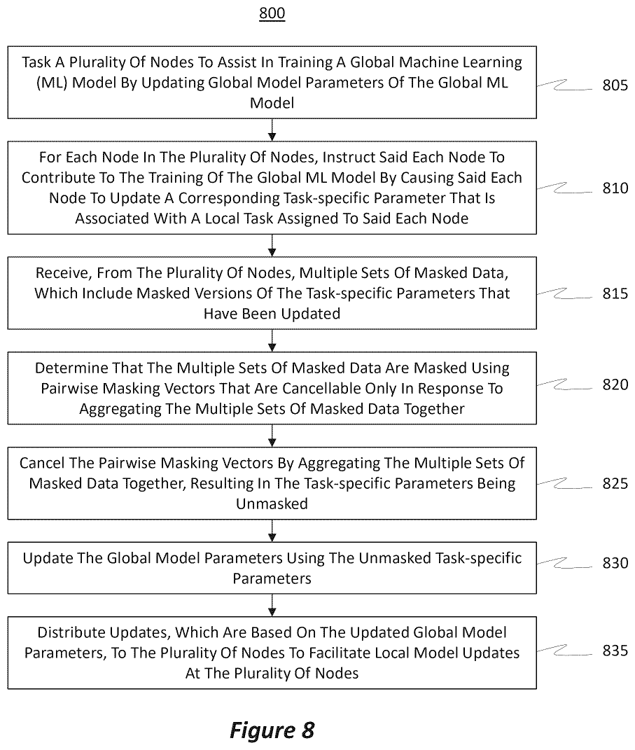

Attention will now be directed to FIG. 8, which illustrates a flowchart of an example method 800 for training a global machine learning model in a distributed manner. Method 800 can be implemented within architecture 100 of FIG. 1; furthermore, method 800 can be implemented by service 105.

Method 800 includes an act (act 805) of tasking a plurality of nodes to assist in training a global machine learning (ML) model by updating global model parameters of the global ML model. Typically, the plurality of nodes is included in a non-independent and identically distributed (non-IID) federation. In some implementations, each node in the plurality of nodes is trained to enable reaction to tasks that have not previously been seen by said each node but that were learned by other nodes in the non-IID federation.

For each node in the plurality of nodes, act 810 includes instructing each node to contribute to the training of the global ML model by causing each node to update a corresponding task-specific parameter that is associated with a local task assigned to each node. Thus, the various nodes are tasked with performing small chunks of the training process.

Act 815 includes receiving, from the nodes, multiple sets of masked data. This masked data includes masked versions of the task-specific parameters that have been updated. Often, the multiple sets of masked data further include task vectors reflecting which one or more tasks each node in the plurality of nodes is responsible for executing. Thus, the masked data can include a combination of the task-specific parameters as well as the identification of which specific task each node was responsible for executing.

Act 820 includes determining that the multiple sets of masked data are masked using pairwise masking vectors. These vectors are cancellable only in response to aggregating the multiple sets of masked data together. In some scenarios, the task vectors have also been masked using the pairwise masking vectors. As a result, both the parameters and the task identification information are obfuscated.

Act 825 includes cancelling the pairwise masking vectors by aggregating the multiple sets of masked data together. This aggregation process results in the task-specific parameters being unmasked.

Act 830 includes updating the global model parameters. This update occurs using the unmasked task-specific parameters.

Act 835 includes distributing updates to the nodes. These updates are based on the updated global model parameters. Also, the distribution of these updates facilitates local model updates at the nodes.

In some scenarios, the multiple sets of masked data include a first set, a second set, and a third set. Optionally, the first set is unmasked using pairwise masking vectors included in both the second set and the third set. The second set can be unmasked using pairwise masking vectors included in both the first set and the third set. The third set can be unmasked using pairwise masking vectors included in both the first set and the second set. Thus, data from one node can be unmasked using data from a different node. Also, in some cases, data from one node can be unmasked only using data from a combination of multiple other nodes.

In some scenarios, a first node and a second node are included in the plurality of nodes, and the first and second nodes execute a common task. Thus, in some scenarios, a task can be concurrently or simultaneously implemented by multiple different nodes. Optionally, the common tasks can be executed in an asynchronous manner and may not overlap. In one example, the first node generates a first task-specific parameter for the common task, and the second node generates a second task-specific parameter for the same common task. In some cases, the first task-specific parameter may be different than the second task-specific parameter even though the tasks are the same.

Optionally, the plurality of nodes is included in a non-independent and identically distributed (non-IID) federation. In such a scenario, the pairwise masking vectors can be created at a start of the non-IID federation. Also, the pairwise masking vectors can be created such that masking values of the pairwise masking vectors are cancelled out when subjected to a summing operation. In some scenarios, each node in the plurality of nodes trains a corresponding local model using local private data. The local models can be updated based on the distributed updates.

In some cases, the pairwise masking vectors are structured to mask both the task-specific parameters and task vectors. The task vectors can include metadata communicated by the plurality of nodes to a central node during each federated learning round. The task vectors can include information of which expert prompt is being trained by which node.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

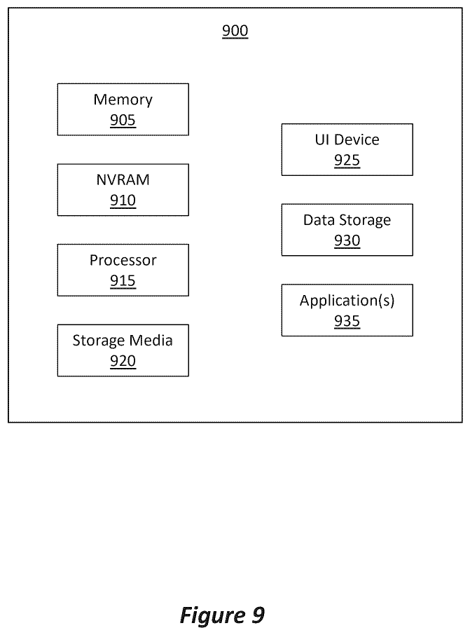

With reference briefly now to FIG. 9, any one or more of the entities disclosed, or implied, by the Figures and/or elsewhere herein, may take the form of, or include, or be implemented on, or hosted by, a physical computing device, one example of which is denoted at 900. Also, where any of the aforementioned elements comprise or consist of a virtual machine (VM), that VM may constitute a virtualization of any combination of the physical components disclosed in FIG. 9.

In the example of FIG. 9, the physical computing device 900 includes a memory 905 which may include one, some, or all, of random access memory (RAM), non-volatile memory (NVM) 910 such as NVRAM for example, read-only memory (ROM), and persistent memory, one or more hardware processors 915, non-transitory storage media 920, UI device 925, and data storage 930. One or more of the memory 905 of the physical computing device 900 may take the form of solid-state device (SSD) storage. Also, one or more applications 935 may be provided that comprise instructions executable by one or more hardware processors 915 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 900 may also be representative of an edge system, a cloud-based system, a datacenter or portion thereof, or other system or entity.

The disclosed embodiments can be implemented in numerous different ways, as described in the various different clauses recited below.

Clause 1. A method comprising: tasking a plurality of nodes to assist in training a global machine learning (ML) model by updating global model parameters of the global ML model; for each node in the plurality of nodes, instructing said each node to contribute to the training of the global ML model by causing said each node to update a corresponding task-specific parameter that is associated with a local task assigned to said each node; receiving, from the plurality of nodes, multiple sets of masked data, which include masked versions of the task-specific parameters that have been updated; determining that the multiple sets of masked data are masked using pairwise masking vectors that are cancellable only in response to aggregating the multiple sets of masked data together; cancelling the pairwise masking vectors by aggregating the multiple sets of masked data together, resulting in the task-specific parameters being unmasked; updating the global model parameters using the unmasked task-specific parameters; and distributing updates, which are based on the updated global model parameters, to the plurality of nodes to facilitate local model updates at the plurality of nodes.

Clause 2. The method of any of the preceding clauses, wherein the multiple sets of masked data further include task vectors reflecting which one or more tasks each node in the plurality of nodes is responsible for executing.

Clause 3. The method of any of the preceding clauses, wherein the task vectors are masked using the pairwise masking vectors.

Clause 4. The method of any of the preceding clauses, wherein the plurality of nodes are included in a non-independent and identically distributed (non-IID) federation.

Clause 5. The method of any of the preceding clauses, wherein each node in the plurality of nodes is trained to enable reaction to tasks that have not previously been seen by said each node but that were learned by other nodes in the non-IID federation.

Clause 6. The method of any of the preceding clauses, wherein the multiple sets of masked data include a first set, a second set, and a third set, and wherein the first set is unmasked using pairwise masking vectors included in both the second set and the third set.

Clause 7. The method of any of the preceding clauses, wherein the second set is unmasked using pairwise masking vectors included in both the first set and the third set.

Clause 8. The method of any of the preceding clauses, wherein the third set is unmasked using pairwise masking vectors included in both the first set and the second set.

Clause 9. The method of any of the preceding clauses, wherein a first node and a second node are included in the plurality of nodes, and wherein the first and second nodes execute a common task.

Clause 10. The method of any of the preceding clauses, wherein the first node generates a first task-specific parameter for the common task, the second node generates a second task-specific parameter for the common task, and wherein the first task-specific parameter is different than the second task-specific parameter.

Clause 11. One or more hardware storage devices that store instructions that are executable by one or more processors to cause the one or more processors to: task a plurality of nodes to assist in training a global machine learning (ML) model by updating global model parameters of the global ML model; for each node in the plurality of nodes, instruct said each node to contribute to the training of the global ML model by causing said each node to update a corresponding task-specific parameter that is associated with a local task assigned to said each node; receive, from the plurality of nodes, multiple sets of masked data, which include masked versions of the task-specific parameters that have been updated; determine that the multiple sets of masked data are masked using pairwise masking vectors that are cancellable only in response to aggregating the multiple sets of masked data together; cancel the pairwise masking vectors by aggregating the multiple sets of masked data together, resulting in the task-specific parameters being unmasked; update the global model parameters using the unmasked task-specific parameters; and distribute updates, which are based on the updated global model parameters, to the plurality of nodes to facilitate local model updates at the plurality of nodes.

Clause 12. The one or more hardware storage devices of any of the preceding clauses, wherein the plurality of nodes is included in a non-independent and identically distributed (non-IID) federation, and wherein the pairwise masking vectors are created at a start of the non-IID federation.

Clause 13. The one or more hardware storage devices of any of the preceding clauses, wherein the pairwise masking vectors are created such that masking values of the pairwise masking vectors are cancelled out when subjected to a summing operation.

Clause 14. The one or more hardware storage devices of any of the preceding clauses, wherein each node in the plurality of nodes trains a corresponding local model using local private data.

Clause 15. The one or more hardware storage devices of any of the preceding clauses, wherein the local models are updated based on the distributed updates.

Clause 16. The one or more hardware storage devices of any of the preceding clauses, wherein the pairwise masking vectors are structured to mask both the task-specific parameters and task vectors.

Clause 17. The one or more hardware storage devices of any of the preceding clauses, wherein the task vectors include metadata communicated by the plurality of nodes to a central node during each federated learning round, and wherein the task vectors include information of which expert prompt is being trained by which node.

Clause 18. The one or more hardware storage devices of any of the preceding clauses, wherein the multiple sets of masked data further include task vectors reflecting which one or more tasks each node in the plurality of nodes is responsible for executing.

Clause 19. A computer system comprising: one or more processors; and one or more hardware storage devices that store instructions that are executable by the one or more processors to cause the computer system to: task a plurality of nodes to assist in training a global machine learning (ML) model by updating global model parameters of the global ML model; for each node in the plurality of nodes, instruct said each node to contribute to the training of the global ML model by causing said each node to update a corresponding task-specific parameter that is associated with a local task assigned to said each node; receive, from the plurality of nodes, multiple sets of masked data, which include masked versions of the task-specific parameters that have been updated; determine that the multiple sets of masked data are masked using pairwise masking vectors that are cancellable only in response to aggregating the multiple sets of masked data together; cancel the pairwise masking vectors by aggregating the multiple sets of masked data together, resulting in the task-specific parameters being unmasked; update the global model parameters using the unmasked task-specific parameters; and distribute updates, which are based on the updated global model parameters, to the plurality of nodes to facilitate local model updates at the plurality of nodes.

Clause 20. The computer system of any of the preceding clauses, wherein the multiple sets of masked data further include task vectors reflecting which one or more tasks each node in the plurality of nodes is responsible for executing.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A method comprising:
tasking a plurality of nodes to assist in training a global machine learning (ML) model by updating global model parameters of the global ML model;
for each node in the plurality of nodes, instructing said each node to contribute to the training of the global ML model by causing said each node to update a corresponding task-specific parameter that is associated with a local task assigned to said each node;
receiving, from the plurality of nodes, multiple sets of masked data, which include masked versions of the task-specific parameters that have been updated;
determining that the multiple sets of masked data are masked using pairwise masking vectors that are cancellable only in response to aggregating the multiple sets of masked data together;
cancelling the pairwise masking vectors by aggregating the multiple sets of masked data together, resulting in the task-specific parameters being unmasked;
updating the global model parameters using the unmasked task-specific parameters; and
distributing updates, which are based on the updated global model parameters, to the plurality of nodes to facilitate local model updates at the plurality of nodes.

2. The method of claim 1, wherein the multiple sets of masked data further include task vectors reflecting which one or more tasks each node in the plurality of nodes is responsible for executing.

3. The method of claim 2, wherein the task vectors are masked using the pairwise masking vectors.

4. The method of claim 1, wherein the plurality of nodes is included in a non-independent and identically distributed (non-IID) federation.

5. The method of claim 4, wherein each node in the plurality of nodes is trained to enable reaction to tasks that have not previously been seen by said each node but that were learned by other nodes in the non-IID federation.

6. The method of claim 1, wherein the multiple sets of masked data include a first set, a second set, and a third set, and wherein the first set is unmasked using pairwise masking vectors included in both the second set and the third set.

7. The method of claim 6, wherein the second set is unmasked using pairwise masking vectors included in both the first set and the third set.

8. The method of claim 7, wherein the third set is unmasked using pairwise masking vectors included in both the first set and the second set.

9. The method of claim 1, wherein a first node and a second node are included in the plurality of nodes, and wherein the first and second nodes execute a common task.

10. The method of claim 9, wherein the first node generates a first task-specific parameter for the common task, the second node generates a second task-specific parameter for the common task, and wherein the first task-specific parameter is different than the second task-specific parameter.

11. One or more hardware storage devices that store instructions that are executable by one or more processors to cause the one or more processors to:
task a plurality of nodes to assist in training a global machine learning (ML) model by updating global model parameters of the global ML model;
for each node in the plurality of nodes, instruct said each node to contribute to the training of the global ML model by causing said each node to update a corresponding task-specific parameter that is associated with a local task assigned to said each node;
receive, from the plurality of nodes, multiple sets of masked data, which include masked versions of the task-specific parameters that have been updated;
determine that the multiple sets of masked data are masked using pairwise masking vectors that are cancellable only in response to aggregating the multiple sets of masked data together;
cancel the pairwise masking vectors by aggregating the multiple sets of masked data together, resulting in the task-specific parameters being unmasked;
update the global model parameters using the unmasked task-specific parameters; and
distribute updates, which are based on the updated global model parameters, to the plurality of nodes to facilitate local model updates at the plurality of nodes.

12. The one or more hardware storage devices of claim 11, wherein the plurality of nodes are included in a non-independent and identically distributed (non-IID) federation, and wherein the pairwise masking vectors are created at a start of the non-IID federation.

13. The one or more hardware storage devices of claim 12, wherein the pairwise masking vectors are created such that masking values of the pairwise masking vectors are cancelled out when subjected to a summing operation.

14. The one or more hardware storage devices of claim 11, wherein each node in the plurality of nodes trains a corresponding local model using local private data.

15. The one or more hardware storage devices of claim 14, wherein the local models are updated based on the distributed updates.

16. The one or more hardware storage devices of claim 11, wherein the pairwise masking vectors are structured to mask both the task-specific parameters and task vectors.

17. The one or more hardware storage devices of claim 16, wherein the task vectors include metadata communicated by the plurality of nodes to a central node during each federated learning round, and wherein the task vectors include information of which expert prompt is being trained by which node.

18. The one or more hardware storage devices of claim 11, wherein the multiple sets of masked data further include task vectors reflecting which one or more tasks each node in the plurality of nodes is responsible for executing.

19. A computer system comprising:
one or more processors; and
one or more hardware storage devices that store instructions that are executable by the one or more processors to cause the computer system to:
task a plurality of nodes to assist in training a global machine learning (ML) model by updating global model parameters of the global ML model;
for each node in the plurality of nodes, instruct said each node to contribute to the training of the global ML model by causing said each node to update a corresponding task-specific parameter that is associated with a local task assigned to said each node;
receive, from the plurality of nodes, multiple sets of masked data, which include masked versions of the task-specific parameters that have been updated;
determine that the multiple sets of masked data are masked using pairwise masking vectors that are cancellable only in response to aggregating the multiple sets of masked data together;
cancel the pairwise masking vectors by aggregating the multiple sets of masked data together, resulting in the task-specific parameters being unmasked;
update the global model parameters using the unmasked task-specific parameters; and
distribute updates, which are based on the updated global model parameters, to the plurality of nodes to facilitate local model updates at the plurality of nodes.

20. The computer system of claim 19, wherein the multiple sets of masked data further include task vectors reflecting which one or more tasks each node in the plurality of nodes is responsible for executing.
